(19) United States
(12) Patent Application Publication
(10) Pub. No.: US 2012/0156101 A1
(43) Pub. Date: Jun. 21, 2012

(54) ASSEMBLY FOR THE CONTROLLED FEEDING AND DELIVERY OF A GAS MIXTURE INTO AN ANALYSIS CHAMBER

(75) Inventor: Norbert Kreft, Meerbusch (DE)

(73) Assignee: AVL EMISSION TEST SYSTEMS GMBH, Neuss (DE)

(21) Appl. No.: 13/322,571

(22) PCT Filed: Apr. 28, 2010
(86) PCT No.: PCT/EP10/55667

§ 371 Date: Mar. 12, 2012

(30) Foreign Application Priority Data
May 29, 2009 (DE) 10 2009 023 224.9

(51) Int. Cl. G01N 21/76

(52) U.S. Cl. 422/83

(57) ABSTRACT

An assembly for a controlled feeding and delivery of a gas mixture into an analysis chamber includes at least one metering line, a flow limiter disposed in the at least one metering line, a first capillary disposed in the at least one metering line downstream of the flow limiter, an analysis chamber configured to receive the gas mixture from the at least one metering line, an outlet line, and a bypass line with a nozzle disposed therein. The bypass line branches off from the at least one metering line downstream of the flow limiter and upstream of the first capillary. The bypass line opens into the outlet line downstream of the analysis chamber.

### CROSS REFERENCE TO PRIOR APPLICATIONS

This application is a U.S. National Phase application under 35 U.S.C. §371 of International Application No. PCT/EP2010/055667, filed on Apr. 28, 2010 and which claims benefit to German Patent Application No. 10 2009 023 224.9, filed on May 29, 2009. The International Application was published in German on Dec. 2, 2010 as WO 2010/136288 A1 under PCT Article 21(2).

### FIELD

The present invention provides an assembly for the controlled feeding and delivery of a gas mixture into an analysis chamber comprising at least one metering line, a first capillary arranged in the metering line, an analysis chamber into which the gas mixture flows from the metering line, and an outlet line.

### BACKGROUND

Assemblies of this type are known, for example, from the field of gas chromatography or chemiluminescence analysis.

The measuring principle of chemiluminescence analysis is based on a spontaneous reaction of nitrogen monoxide with ozone. These are converted into nitrogen dioxide and oxygen, wherein, after the reaction, a part of the thus generated nitrogen dioxide molecules are in an excited state. During the transition into the basic state, the excess energy is emitted in the form of optically measurable radiation whose intensity is directly proportionate to the previously existing concentration of nitrogen monoxide in the gas mixture.

In the above measuring method, problems are caused by the quench effect. This effect occurs when part of the nitrogen dioxide monoxides transfer their energy to other molecules so that no radiation is emitted. This effect becomes especially clear when a portion of water or carbon dioxide in the mixed gas changes in comparison to the calibration gas.

An assembly for analysis of the NO portion in a gas mixture is described in DE-OS 2 225 802. DE-OS 2 225 802 describes supplying a gas mixture containing nitrogen oxides laminarily in a dosed manner to a reaction chamber via a capillary arranged in a sample line. A reaction mixture containing ozone is additionally supplied to the reaction chamber via a second line so that the mixture in the chamber will react in the described manner. The radiation thus generated is measured and, on this basis, the portion of nitrogen oxides is detected by a light-sensitive device. Via a suction pump, the mixture is conveyed out of the reaction chamber. This measurement can be performed continuously. In order to suppress the quench effect caused by carbon monoxide in the mixed gas of the sample during measurement of combustion-engine exhaust gases, a reaction mixture containing about four times the quantity of oxygen is supplied to the sample gas in the reaction chamber. This dilution is intended to reduce the quench effect.

The use of such dilution approaches is also described in DE 197 46 446 C2 where the dilution is not performed in the reaction chamber, but upstream of an NOₓ converter. This converter serves to convert NOₓ to NO. N₂ is used as a dilution gas.

Both of the above approaches, however, have the disadvantage that the dilution cannot fully preclude the quench effect without also causing residual measuring inaccuracies.

### SUMMARY

An aspect of the present invention is to provide an assembly for the controlled feeding and delivery of a gas mixture into an analysis chamber which reduces the quench effect without adding a dilution gas and/or where the quench effect can be eliminated entirely.

The present invention provides an assembly for a controlled feeding and delivery of a gas mixture into an analysis chamber which includes at least one metering line, a flow limiter disposed in the at least one metering line, a first capillary disposed in the at least one metering line downstream of the flow limiter, an analysis chamber configured to receive the gas mixture from the at least one metering line, an outlet line, and a bypass line with a nozzle disposed therein. The bypass line branches off from the at least one metering line downstream of the flow limiter and upstream of the first capillary. The bypass line opens into the outlet line downstream of the analysis chamber.

### BRIEF DESCRIPTION OF THE DRAWINGS

The present invention is described in greater detail below on the basis of embodiments and of the drawing in which:

FIG. 1 shows an embodiment of an assembly for the controlled feeding and delivery of a gas mixture into an analysis chamber of the present invention.

### DETAILED DESCRIPTION

In an embodiment of the present invention, connection of a nozzle to one or a plurality of capillaries makes it possible for the quench effect to be compensated for by adjusting the throughflow through the reaction chamber, since the throughflow through the nozzle will change dependent on the gas density while the throughflow through the capillary will vary dependent on the viscosity of the gas. Thus, by means of a well-aimed interconnection, automatic changes in the throughflow can be achieved which result from the changed compositions of the gas mixture. This means that, for example, in a reaction chamber of a chemiluminescence analyzer, when portions of carbon dioxide or water increase, the sample flow must be increased by the interconnection and, when portions of carbon dioxide or water decrease, the sample flow must be decreased. In the arrangement according to the present invention, the throughflow through the nozzle will decrease with increasing density, the decrease being proportionate to the root of the density, whereas the throughflow through the capillary will decrease proportionately to an increasing viscosity. In comparison to nitrogen, carbon monoxide as an interference gas has a higher density as well as a lower viscosity. The throughflow through the capillary will thus increase while, at the same time, the throughflow through the nozzle will decrease when the mixed gas contains more carbon dioxide. The flow limiter, arranged at an upstream position, provides for a setting of the volume flow and of the output pressure at a constant input pressure dependent on the composition of the gas mixture.

In an embodiment of the present invention, the flow limiter can, for example, be a second capillary. This allows for an output pressure to be set in a simple manner.

It can be advantageous if the nozzle is operated in a critical state. In this case, no change of the output pressure can influence the throughflow since the throughflow is dependent solely on the input pressure.

In an embodiment of the present invention, the analysis chamber can, for example, be a reaction chamber of a chemiluminescence reactor so that, by the arrangement of the capillary and the nozzle, the measurement values of the reactor remain substantially unchanged in situations where the viscosity is changed due the presence of water vapor or carbon monoxide caused by the increase of the throughflow through the reaction chamber, since the lower activity of the nitrogen oxides are compensated for by the increased throughflow.

In an embodiment of the present invention, the assembly can, for example, comprise a pump arranged downstream of the analysis chamber in the outlet line, thus safeguarding the conveyance of the mixed gas.

In an embodiment of the present invention, a dilution channel for introducing a dilution gas in the metering line can, for example, be provided downstream of the first capillary. Such an arrangement allows for a complete compensation of the quench effect to be accomplished, so that a very high measurement accuracy can be obtained.

In an embodiment of the present invention, there is provided an assembly for the controlled feeding and delivery of a gas mixture into an analysis chamber by which, with the aid of an increased portion of water vapor and carbon dioxide, the occurring quench effect can be distinctly reduced and, depending on given circumstances, eliminated entirely.

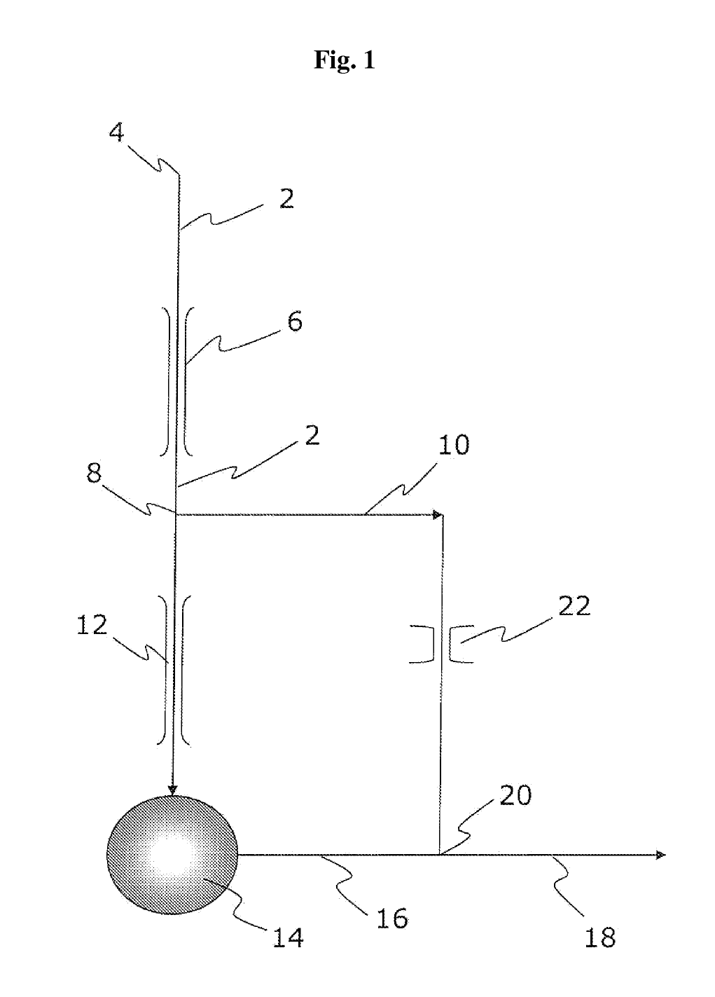

An embodiment of an assembly for the controlled feeding and delivery of a gas mixture into an analysis chamber as provided by the present invention is schematically illustrated in the FIG. 1 and will be described hereunder.

The FIG. 1 shows a metering assembly comprising a metering line 2 into which a gas mixture can flow via an inlet 4. In metering line 2, a flow limiter 6 is arranged for a defined setting of the conveyed volume flow and of the compensation pressure in dependence on a constant input pressure and on the composition of the gas mixture.

Downstream of the flow limiter 6, a branch line 8 is arranged at which a bypass line 10 branches off from the metering line 2, so that the mixed gas flow is divided into two flows depending on its viscosity and density and on the available cross section of the lines 2,10.

Downstream of branch line 8, a first capillary 12 is arranged in the metering line 2, via which the partial flow of the gas mixture flows from metering line 2 into an analysis chamber 14 which in the present embodiment is formed as a reaction chamber of a chemiluminescence analyzer.

From there, the partial flow streams into outlet line 16 in which a pump, not shown, is arranged for conveyance so as to generate a sufficient pressure gradient between inlet 4 and an outlet 18 of outlet line 16. Depending on the given case, a conveyance without a pump can be provided.

Outlet line 16 is also entered by the bypass line 10 in which a nozzle 22 is arranged between the branch line 8 and a mouth 20.

The manner of operation will hereinafter be described, wherein the flow limiter 6 is formed as a second capillary having an inner diameter of 0.3 mm and a length of 134 mm, the first capillary 12 has the same inner diameter, but a length of 88 mm, and the nozzle 22 is provided as a critical nozzle with a volume flow of 30 ml/min N₂ at a pressure of 299 hPa.

At an operating temperature of 80° C., the above features (with pure nitrogen being supplied via metering line 2 and with an inlet pressure p₁ of 600 hPa upstream of the second capillary 6) will result in a volume flow of 60 ml/min through the capillary. The pressure p₂ upstream of nozzle 22 and respectively upstream of the first capillary 12 will then be 299.2 hPa. As a result, the volume flow through the first capillary 12 and the nozzle 22 will each time be about 30 ml/min. In the present example, the pressure downstream of reaction chamber 14 is about 30 hPa, this being determined by the characteristic line of the pump, but having no influence on the previous operating states. A quench effect does not exist at this moment because no quenching gases are present.

If the composition of the gas flow is changed, for example, so that 10% water and 10% carbon dioxide are contained in the gas flow, the pressures and the gas flows will change in such a manner by the inventive arrangement that the throughflow through the first capillary 12 will increase to 32.3 ml/min, the throughflow through the second capillary will increase to 62.55 ml/min and the throughflow through the nozzle will increase to 30.25 ml/min. At the same time, the pressure p₂ downstream of the second capillary will increase to 302.9 hPA, while the input pressure p1 will remain constant. Downstream of the second capillary 6, due to the above described influence of the change of viscosity and density of the gas flow, the pressure p₂ will increase to 302.9 hPa. This means that that the throughflow through the reaction chamber will be increased by 7.67%. This increase is distinctly above the increase obtainable by the known pure capillary assembly.

It has been found that in particular at a proportionality between the quench gases water vapor and carbon dioxide, that the increase of the throughflow is substantially proportionate to the quench effect occurring in the measurement of nitrogen oxides by chemiluminescence, so that this quench effect can be compensated for by the assembly of the present invention.

Existing carbon dioxide in the mixed gas will increase the density while it will decrease with the existence of water vapor. Under the effect of the two already existing interference gases, the viscosity of the mixed gas will decrease. Thus, at capillary 12, an increased throughflow will be generated due to the decreasing viscosity, while the throughflow at the nozzle 12 will slightly increase because it will change only in proportion to the root of the density and because, in the existing mixed gas, there only exists a slight decrease of the density, wherein said increase is distinctly lower than in the parallel-connected capillary 12. The resultant increase of the volume flow through the reaction chamber 14 compensates for the occurring quench effect during measurement of the nitrogen portion with the aid of chemiluminescence, which is not achieved by a pure capillary assembly.

It should be evident that the assembly according to the present invention is not limited to the described embodiments; reference should also be had to the appended claims. Thus, for instance, other types of flow limiters can be used, or the assembly can be used for analysis chambers other than the reaction chamber of a chemiluminescence analyzer. Conveyance can be performed with or without pump(s), depending on the ambient conditions. An additional reduction of the quench effect can also be achieved by further dilution of the mixed gas.

What is claimed is:

1-6. (canceled)

7. An assembly for a controlled feeding and delivery of a gas mixture into an analysis chamber, the assembly comprising:
at least one metering line;
a flow limiter disposed in the at least one metering line;
a first capillary disposed in the at least one metering line downstream of the flow limiter;
an analysis chamber configured to receive the gas mixture from the at least one metering line;
an outlet line; and
a bypass line with a nozzle disposed therein, the bypass line branching off from the at least one metering line downstream of the flow limiter and upstream of the first capillary, the bypass line opening into the outlet line downstream of the analysis chamber.

8. The assembly as recited in claim 7, wherein the flow limiter is a second capillary.

9. The assembly as recited in claim 7, wherein the nozzle is a critical nozzle.

10. The assembly as recited in claim 7, wherein the analysis chamber is a reaction chamber of a chemiluminescence reactor.

11. The assembly as recited in claim 7, further comprising a pump disposed downstream of the analysis chamber in the outlet line.

12. The assembly as recited in claim 7, further comprising a dilution channel opening into the at least one metering line downstream of the first capillary, the dilution line being configured to introduce a dilution gas.
